(19) United States
(12) Patent Application Publication
(10) Pub. No.: US 2025/0076853 A1
(43) Pub. Date: Mar. 6, 2025

(54) METHOD FOR OPERATING A NUMERICALLY CONTROLLED MACHINE TOOL

(71) Applicant: Gildemeister Drehmaschinen GmbH, Bielefeld (DE)

(72) Inventors: Martin FRYE, Wadersloh (DE); Kai LITWINSKI, Hannover (DE); Gerhard KOHLMEYER, Warburg (DE); Patrick VOGT, Bielefeld (DE); Edmond BASSETT, Hannover (DE); Dietmar MINNEKER, Lengerich (DE)

(21) Appl. No.: 18/823,406

(22) Filed: Sep. 3, 2024

(30) Foreign Application Priority Data
Sep. 4, 2023 (DE) 102023123715.2

(51) Int. Cl. G05B 19/4155; G05B 19/409

(52) U.S. Cl. CPC G05B 19/4155; G05B 19/409

(57) ABSTRACT

A method for operating a numerically controlled machine tool to design, create, modify and/or execute a sequence program for machining a workpiece, comprising the steps of: displaying, on a graphical user interface, a project library with a plurality of project templates. Each project template comprises a preconfigured sequence of operations for machining the workpiece according to the sequence program. selecting a project template by a user. displaying, on the user interface, a parameter display for setting a plurality of process parameters for the sequence program. setting the plurality of process parameters by the user and storing the process parameters. displaying, on the user interface, a schedule with a plurality of operations and an order of the plurality of operations. displaying, on the user interface, an operation library with a plurality of operation templates. selecting an operation template by the user and placing and/or relocating the operation template at a desired position of an operation in the schedule. repeating the selecting and placing and/or relocating of operation templates until the schedule is completed. generating a sequence program with corresponding machine and/or control functions according to the schedule and the process parameters and outputting the sequence program to a controller of the machine tool via a control interface.

### FIELD OF THE INVENTION

The present invention relates to a method for operating a numerically controlled machine tool, to an operating device for a numerically controlled machine tool, to a control apparatus for a numerically controlled machine tool and to a machine tool. In particular, it should be made possible to create a program sequence for machining a workpiece directly at the control apparatus of the machine tool, so that a software application on a PC can be dispensed with.

### BACKGROUND OF THE INVENTION

In the prior art, it is known to control workpiece machining on numerically controlled machine tools by means of an NC control device, which is usually integrated on the machine tool. In particular, the NC control device controls controllable actuators, for example spindle drives, axle drives of axles of the machine tool and further machine functions of the machine tool, for example on the basis of an NC program generated by a CAD/CAM system or programmed by a machine operator.

In EP 2 891 020 A1, an extended controller of a numerically controlled machine tool has been proposed, in which a further control device or operating device, which extends the operation or control of the operator of the machine tool compared to the functions of an NC control device, is provided in a manner superordinate to the NC control device.

European patent application No. EP 3 767 405 A1 discloses an operating device for use on a numerically controlled machine tool and systems, apparatuses and methods for operating and controlling one or more numerically controlled machine tools in a production system. A machining job for machining one or more workpieces on the machine tool is controlled on the basis of a machining sequence selectable by the operator via a user interface and corresponding machine or control functions are called up on the control device via the control interface.

German patent application No. DE 10 2019 215 497 A1 describes a method for controlling a numerically controlled machine tool on the basis of control data having an NC program, which are provided on a control apparatus of the machine tool and which are analyzed on the control apparatus for identifying a subdivision of the NC program into a plurality of program sections indicated in the control data. A graphical user interface is generated on the control apparatus on the basis of the program sections according to the subdivision of the NC program.

Originally, it was necessary in part to program a program for machining a workpiece by a numerically controlled machine tool by means of G code. Due to the high complexity of such programs, even a person skilled in the art can quickly lose an overview. There is thus a need to make the programming of machining operations or entire sequences on the controller simpler.

### Problem to be Solved

Starting from the prior art, the programming of a machine tool is to be simplified. In particular, the programming is to be made more efficient and intuitive. Furthermore, errors in the programming are to be avoided in that, for example, logic tests or plausibility tests are already performed during the configuring of a program sequence.

### Solution to Problem

According to a first aspect of the present invention, a method for operating a numerically controlled machine tool according to claim 1 is provided. A second aspect of the present invention relates to an operating device for a numerically controlled machine tool according to claim 18. A third aspect of the invention relates to a control apparatus according to claim 20 and a fourth aspect relates to a machine tool according to claim 21. Further aspects of the present invention are set forth in the dependent claims, the drawings and the following description of exemplary embodiments.

The method according to the invention allows a user in a particularly intuitive manner to generate sequence programs for numerically controlled machine tools for machining a workpiece directly by means of corresponding input devices on the machine controller. For this purpose, the user is provided with a graphical user interface as a human-machine interface for inputting input information by the user and outputting output information to the user.

The graphical user interface can be displayed in particular on a touchscreen of the machine controller, which preferably enables gesture control. The program sequence can be displayed visually to the user via the graphical user interface, so that the sequence is simple and intuitive to create, understandable and easy to machine. Furthermore, parameters can be visually illustrated by images or animations in order to make this aspect of the machining particularly intuitive. Further preferably, the operation of the graphical user interface is to be carried out particularly simply and intuitively. Further preferably, a specific sequence of a project template can be displayed in a detailed view.

A project template is, for example, an NC program with a preconfigured sequence for the production of a component or the machining of a workpiece without the component-specific or workpiece-specific program content, which can then be supplemented by the user himself.

Further preferably, the graphical user interface can be executed as part of an app, in particular as a CELOS app or as PC software, which can be used via a desktop computer or as a cloud-based application in order to create programs for one or a plurality of machine tools. Particularly preferably, the app can even be executed on a smartphone or tablet computer.

In a method step, a project library with a plurality of project templates is displayed on the user interface. Each project template comprises a preconfigured sequence of operations for machining the workpiece according to the sequence program. Project templates can preferably also be created, modified and stored by the user.

If the user selects a project template, for example, a parameter display for setting a plurality of process parameters for the sequence program can be displayed on the user interface. This plurality of process parameters can be edited by the user on the graphical user interface. The process parameters can subsequently be stored. The parameter display can be displayed visually in particular together with an explanatory illustration.

In an editor window of the user interface, a schedule with a plurality of operations and an order of the plurality of operations is displayed, for example as a table with a plurality of columns and rows. The individual cells of the table can each represent an individual operation (a work step or a machining step). The rows are executed successively in the displayed order from top to bottom, for example. Cells in a same row but different columns can represent steps executed simultaneously, for example.

An individual operation or an operation can be in particular an individual work step which describes, for example, how a bezel is to be moved. In other words, individual operations can define in particular individual movements of actuators of the machine tool. An entire schedule can describe a machining of a workpiece, for example a cutting machining.

Furthermore, an operation library with a plurality of operation templates is displayed on the user interface. An operation template corresponds to an individual operation or work step which can be adjusted to the desired machining of the workpiece by adjusting parameters. As parameters of operations, for example, a movement path, a plurality of coordinates, a rotational speed of a spindle, a tool used, etc. can be set.

The user can generate the sequence program by selecting operation templates and placing them at a desired position (cell) in the schedule. In addition, the user can relocate already placed operation templates in the schedule. This selecting and placing or relocating can be performed, for example, by a “drag and drop” operation. The parameters of the operation templates can subsequently be adjusted. The parameters can preferably also be adjusted automatically if the parameters have already been set in another step.

The schedule can be completed by repeated selecting and placing and/or relocating of operation templates. A sequence program with corresponding machine and/or control functions is subsequently generated and output according to the schedule and the process parameters, for example to a controller of the machine tool via a control interface. In particular, a program can be compiled in G code on the basis of the created schedule. Particularly preferably, the corresponding G code or NC code can be displayed and machined in a further window. The machining of the code can preferably also be transferred back into the visual schedule. In other words, the content of a sequence program or an operation can preferably be synchronized bidirectionally between the visual representation and the NC controller. In this case, all changes made can preferably be highlighted and conflicts that arise can be displayed.

An operating device comprises a processing device for executing control and operating applications, a control interface for connecting the processing device to a control device of the machine tool and a user interface for displaying a graphical user interface as a human-machine interface for inputting input information by a user and outputting output information to the user. According to the invention, the processing device is configured to perform a method according to the invention.

A control apparatus according to the invention for a numerically controlled machine tool having a control device for controlling machine functions of the machine tool comprises an operating device according to the invention connected or connectable to the control device.

### PREFERRED EMBODIMENTS

Preferred embodiments and modifications which can be used individually or in combination with one another are set forth in the dependent claims.

The visual schedule can preferably be translated into G code or NC code and displayed in an editor. As an editor for editing the schedule, in particular a smart editor can be used which can detect and highlight syntax errors and semantics errors. NC commands can preferably be automatically supplemented or completed during the input. Particularly preferably, an AI can be integrated which helps the user to generate a sequence program by, for example, generating NC code in the editor after the user has written a prompt, for example, via a chat input.

The editor for NC code and/or the editor for editing the visual schedule of a multi-channel CNC machine tool can be embodied in particular as a browser-based application which can be executed on a controller, a PC, a server or a mobile terminal of a user. The editor preferably serves for the graphically supported design, creation and modification of NC programs independently of the controller of the machine tool. Here, in particular multi-touch gestures can be used.

Preconfigured and user-friendly visualized project and program templates can enable a fast, intuitive and simple construction of the schedule. An NC program generated therefrom can be constructed in particular in a parameterized and structured manner and contain preconfigured operating commands of peripheral devices of the machine tool (for example rod loaders and robots), raw and finished part handling (for example advancing rod, component transfer, bezel positioning, finished part unloading, etc.).

Particularly preferably, a sequence program optimized for an NC controller is generated with the associated program structure as a result. This can be sent into an NC memory of the controller of the machine tool and always remain synchronized bidirectionally with the content of the schedule.

Preferably, the project templates are adopted in a parameterized manner. The parameters can preferably be adjusted or set and stored in a separate window in the graphical user interface. In this case, explanatory illustrations can preferably be displayed which represent, for example, the meaning of the individual parameters on the basis of a sketch or an animation (for example GIF files) or the like.

Each operation template can be, in particular, a sub-program comprising preconfigured machining templates which allow the user, for example, to design a component-specific or workpiece-specific machining part. An operation template comprises, for example, basic definitions of machining planes (for example end plane, surface plane, etc.). Each sub-program can comprise, for example, a portion of a preprogrammed NC code. Operation templates can preferably be created or edited and stored by the user. Similarly to in the case of project templates, an explanatory illustration such as, for example, an animation or a drawing can be displayed for each operation template, said explanatory illustration graphically explaining the operation of the operation template such that the user can grasp the function within seconds. Preferably, the specific content of an operation template or the corresponding NC code or the like can be displayed in a further view.

The selecting and placing or relocating of the operation templates and operations can particularly preferably be performed by gesture control, which can comprise, for example, dragging and dropping (“drag and drop”). As a result, a particularly simple and intuitive editing by the user can be enabled.

Preferably, the operation templates and operations can each be dynamically adjusted to the desired position in the schedule during the selecting and placing and/or relocating. This dynamic adjustment can be carried out in particular as a function of already existing operation templates and operations in the schedule. It can thus be ensured that the individual operation templates and operations are compatible with one another. The checking can be performed, for example, by means of a plausibility check or a logic test. Here, it is checked, for example, whether the operation of a first channel is compatible with an operation of a further channel at the same time, or in which order the respective operations can be expediently executed. In order to enable this, the respective operation templates can have NC code sections or check sequences, which can be compared with corresponding NC code sections or check sequences of other operation templates in the schedule.

Particularly preferably, a collision can be avoided by checking and evaluating the individual operations already during the addition and/or shifting of operation templates in that, for example, previously checked movement paths are used. Furthermore, the operation templates can be optimized in advance in order to make the sequences particularly efficient and low-risk or collision-free.

The available positions in the schedule can be dynamically adjusted during the selecting and placing and/or relocating of operation templates or operations. For example, free cells in the tabular schedule can already be checked for compatibility during the selecting of an operation template. Correspondingly, only technically expedient cells may be displayed as an available destination of the placing. If the user attempts to place an operation template at a non-available or non-compatible cell, this can be prevented or a corresponding indication can be output.

The sequence program can preferably be automatically generated according to the schedule. For this purpose, for example, a suitable compiler can be used which translates the graphical schedule into a corresponding machine code or NC code.

Control structures can be automatically and dynamically generated and/or adjusted during the selecting and placing of operation templates in the schedule. Control structures can comprise, for example, jump marks.

The settable process parameters can be dependent in particular on the machine tool used. Particularly preferably, the settable process parameters are displayed graphically. A particularly simple and intuitive operation can be facilitated by the graphical representation.

Preferably, the process parameters comprise at least one of the following:
chucking means dimensions of a work spindle;
a clamping force of the work spindle;
workpiece zero points;
workpiece dimensions.

Dimensions and positions can preferably be indicated in millimeters or inches. Preferably, a three-dimensional or two-dimensional illustration can be displayed which explanatorily represents these dimensions and positions.

The schedule comprises a graphical and interactive representation having a row for each operation and a column for each tool carrier (channel) and each workpiece carrier (rotary spindle). In a milling machine, a channel can correspond to a tool carrier (the milling spindle).

The schedule can each have a column for each tool carrier and for each workpiece carrier. A workpiece can each be clamped into the main spindle and/or counter-spindle.

Preferably, the method can be integrated in the controller of the machine tool. Particularly preferably, the method is performed by an application on a control device of the machine tool. In alternative embodiments, an application or a part of the application can also be executed on a computer or in a cloud or on a geographically remote server.

The plurality of operations can preferably comprise at least one of the following:
accepting a sequence program associated with the schedule;
equipping or preparing one or more chucking means required for the sequence program on the machine tool;
setting up one or more tools required for the sequence program on the machine tool;
loading and/or preparing one or more tools required for the sequence program on the machine tool;
loading and/or programming one or more NC codes, NC programs and/or NC program portions required for the sequence program;
executing one or more NC codes, NC programs and/or NC program portions required for the sequence program;
executing a process monitoring application;
documenting one or more machining processes associated with the sequence program;
performing an automated quality check of one or more machined workpieces;
outputting the sequence program;
automatically assembling workpiece pallets;
automatically loading workpiece pallets;
automatically resorting workpieces to workpiece pallets;
setting a clamping position of a workpiece;
changing from one clamping position to another clamping position;
automatically measuring workpieces;
automatically loading a tool magazine of the machine tool;
automatically setting up tools on the machine tool;
automatically resorting tools on the tool magazine; and/or
performing one or more cleaning, maintenance, servicing and/or service applications on the machine tool.

The input information can comprise one or more elements from the following list:
model data indicating a CAD model of one or more workpieces, one or more workpiece parts and/or one or more tools;
NC data indicating one or more NC codes, one or more NC programs and/or one or more NC program portions;
job data indicating job data associated with workpiece processing;
tool data indicating information about one or more associated tools;
tool list data indicating a list of a sequence program or tools associated with workpiece processing, respectively,
chucking means data indicating information about one or more associated chucking means; and/or
chucking means list data indicating a list of a sequence program or chucking means associated with workpiece processing, respectively.

Each project template can preferably comprise an animation and/or an explanation in text form and/or a graphical illustration of a sequence included in the project template. Furthermore, voice outputs can explain the operations of a project template. By the graphical representation of the operations, the user can particularly quickly and easily understand which operations are executed by the machine. The animation or the description can particularly preferably also be dynamically adjusted to changed parameters of the project template.

A preferred operating device comprises a network interface for connecting the processing device to a server.

### BRIEF DESCRIPTION OF THE DRAWINGS

Further advantageous embodiments are described in more detail below with reference to an exemplary embodiment which is illustrated in the drawings but to which the invention is not restricted. The drawings show schematically:

FIG. 1 illustrates a graphical user interface for selecting project templates.

FIG. 2 shows a setting mask for comprehensive project parameters.

FIG. 3 shows an exemplary view of a library with operation templates.

FIG. 4 illustrates an exemplary view of a graphical user interface for creating a schedule.

FIG. 5 illustrates a smart editor with intelligent functions.

FIG. 6 shows an exemplary view with a schedule and G code.

FIG. 7 illustrates an exemplary schedule.

FIG. 8 illustrates parameter settings of an integrated handling.

FIG. 9 illustrates an operation template for rotating in a plane G18.

FIG. 10 illustrates an operation template for puncturing.

FIG. 11 illustrates an operation template for measuring an outer diameter.

FIG. 12 shows a flowchart illustrating an exemplary embodiment of a method according to the invention.

FIG. 13 illustrates a schematic view of an exemplary embodiment of a machine tool with NC control.

### DETAILED DESCRIPTION OF EMBODIMENTS

In the following description of preferred embodiments of the present invention, identical reference signs denote identical or comparable components.

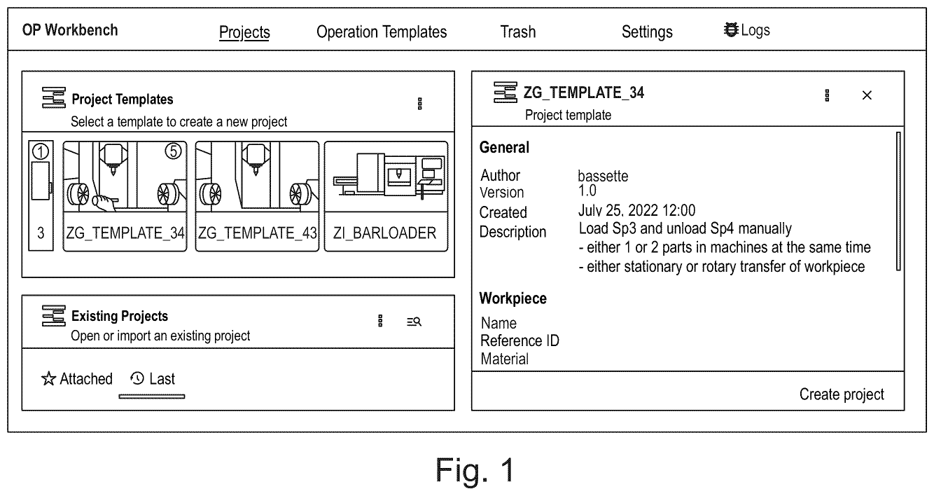

FIG. 1 illustrates a graphical user interface for selecting project templates. This view can for example be displayed as a home screen as a fast entry for creating a schedule. On the left side, an overview of project templates is shown, which represents a section of a library with a plurality of project templates. For each project template, an explanatory image is displayed as a visual brief description. When the user, for example, touches such an overview image or places a mouse pointer over it, for example a short animation of the corresponding sequence can be displayed.

On a right side of the screen in FIG. 1, details of the currently selected project template are displayed. For example, an author, a version, a creation date, a description text, etc. can be displayed. In an upper region of the screen, a menu selection is displayed which allows the user to select between the selection screen of the project templates and a selection screen of operation templates, a selection screen for settings, etc. By clicking on the link “create project”, a new schedule can be created on the basis of the selected project template.

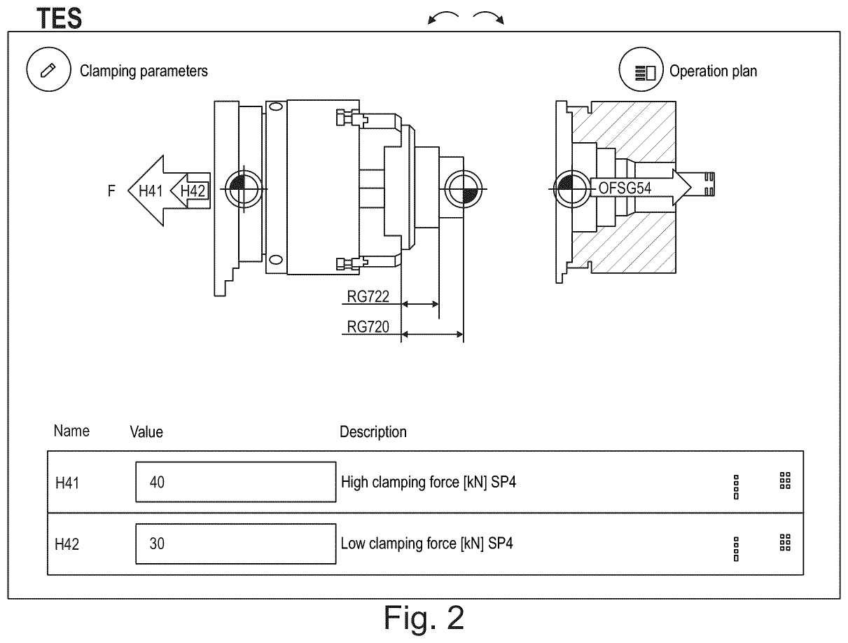

FIG. 2 shows a setting mask for comprehensive project or process parameters. This can be displayed, for example, after selecting a project template. In the present example, for example, clamping parameters of a main spindle and/or of a counter-spindle, such as, for example, a clamping force or a range for the clamping force, can be set. Furthermore, in this case, for example, chucking means dimensions, component zero points, workpiece dimensions, etc. can be set and/or modified.

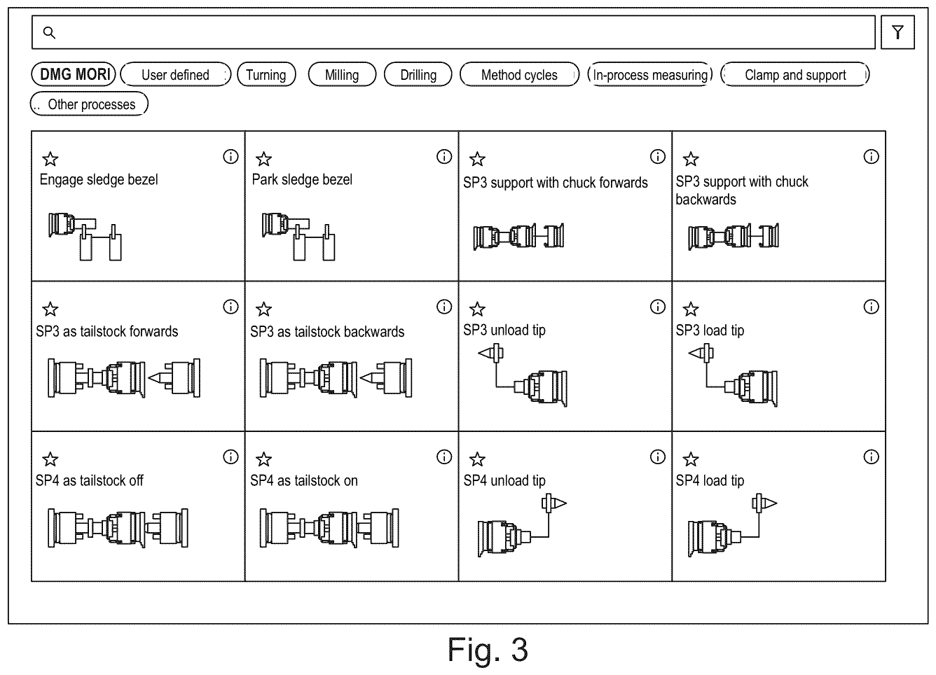

FIG. 3 shows an exemplary view of a library with operation templates. The displayed operation templates can be divided, for example, into functional groups such as turning, milling, drilling, measuring, clamping, etc. For each operation template, an explanatory image is displayed which allows the user to particularly quickly recognize and understand the corresponding operation. An operation can be defined by dragging an operation template into the schedule. For example, the user can drag a desired operation template to a position of main spindle or counter-spindle or channel 1 or channel 2 in the schedule. All synchronous marks (wait) or filling operations necessary for this can be automatically generated here. These synchronous marks (or jump marks) allow a safe break-off and a re-entry into the NC program of the production.

For each operation template, a detailed view can be called up which describes the operation template in detail and can display additional information.

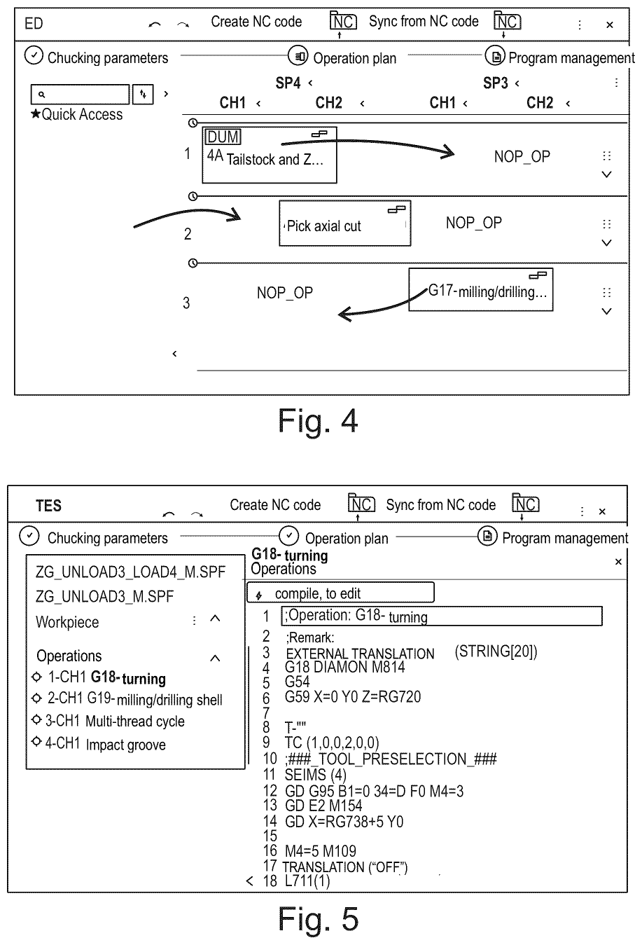

FIG. 4 illustrates an exemplary view of a graphical user interface for creating a schedule for a machine tool with a main spindle SP4 and a counter-spindle SP3. In the case of two-channel machines, each spindle is additionally shown two channels CH1 and CH2 in each case. The schedule (“operation schedule” in FIG. 4) has here a plurality of rows which are executed successively in the order from top to bottom.

FIG. 5 illustrates a smart editor with intelligent functions. The editor is part of the application for generating a sequence program and allows the machining of NC code or G code. The editor can represent the G code in a structured manner and enables a simple navigation between individual operations. NC commands can be verified by the editor in order to avoid conflicts. The represented code corresponds to the operations in the schedule and can be automatically adjusted as a function of the remaining operations. In a preferred embodiment, the user can be assisted by an AI in order to automatically generate or complete the G code.

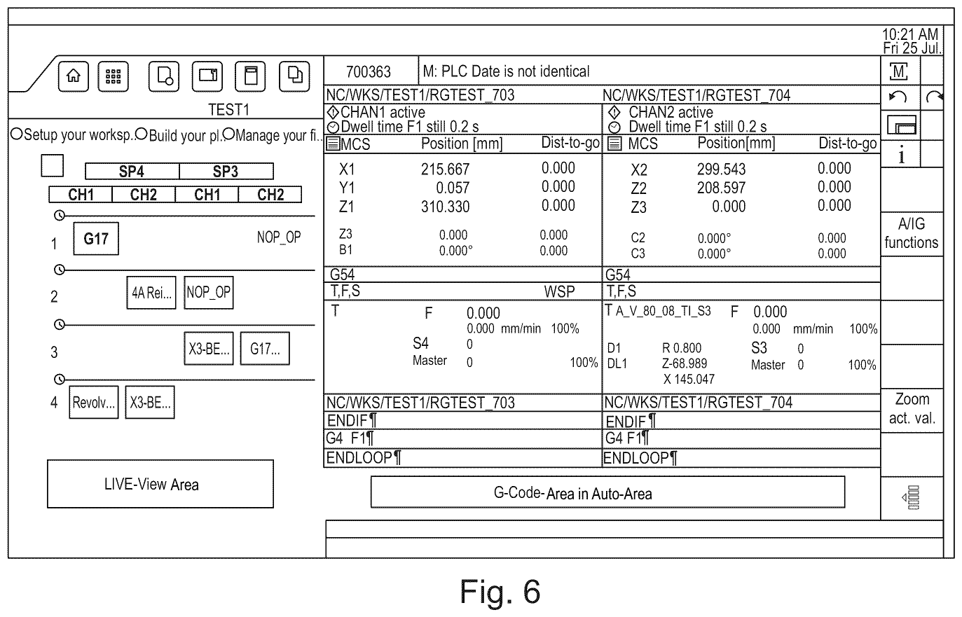

FIG. 6 shows an exemplary view with a schedule and G code. On the left side, a region is shown where the schedule is displayed when executing the generated sequence program. On the right side, the current values of the controller are shown.

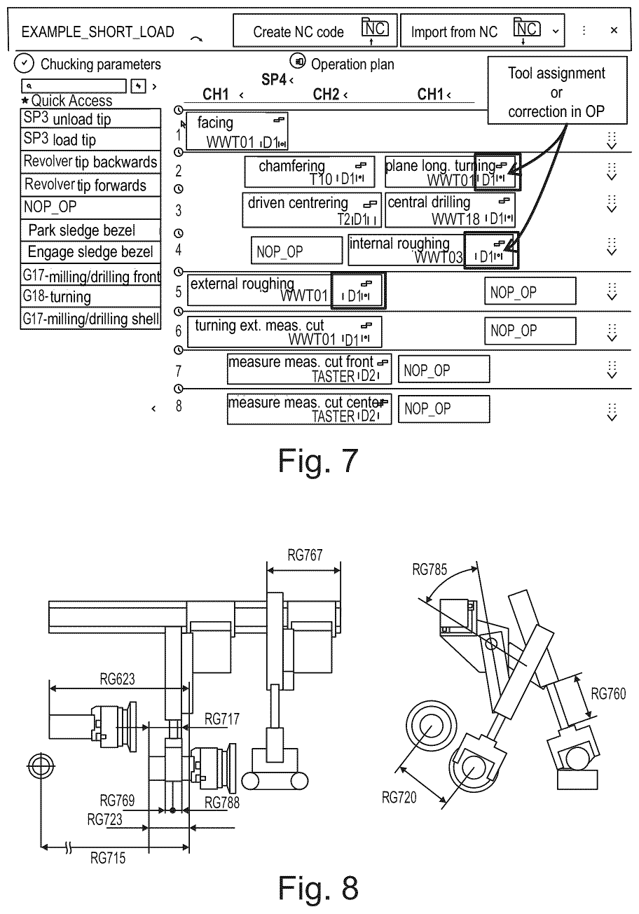

FIG. 7 illustrates an exemplary schedule. Here, the schedule is a workpiece-specific deployment plan for all tools used. The schedule shows which machining operation is used with which tool for which feature on the component. As a result of the simplified representation, the user can easily make changes and adaptations in the sequence (position) and content of the respective operation. The user can easily tap on an operation and from there call up or correct the tool used or make changes to parameters.

In the present example, each operation in the schedule is displayed as a tile or rectangle with a brief description. In addition, icons are shown which can display further information about the tool used or the operation. By tapping or clicking on a tile, further information can be displayed or changes can be made. By means of “drag & drop”, the individual tiles in the schedule can be shifted and rearranged.

FIG. 8 shows the parameter settings of an integrated handling. The use of an integrated handling, in this case as a pick-up device, requires the inputting of different setting parameters. These parameters are defined as RG variables. The clear assignment of the parameters to the variables to be seen in the illustration enables the user a safe operation and intuitive handling of the pick-up device. FIG. 8 shows, by way of example, the unloading of the finished workpiece from the counter-spindle (SP3) by means of an unloading device.

FIG. 9 illustrates an operation template for rotating in the plane G18. The representation visualizes the rotation plane G18 by a marked surface on the X-Z plane of the coordinate system on the workpiece. The operation template offers the user a program envelope which contains the basic technological data. These include the selection of the machining plane, approaching and departing movements on the workpiece and the possibility of incorporating cutting values, coolant commands and tools into the NC code by inputting in the “property mask” of the respective operation template. The user can subsequently supplement the workpiece-specific program code.

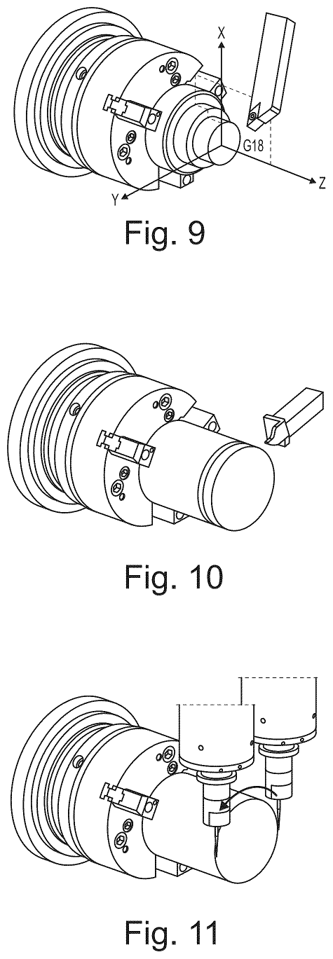

FIG. 10 illustrates an operation template for puncturing. The illustrated illustration illustrates the specific strategy for radial puncturing in the operation template. So that a controlled chip breakage can be produced in the case of long-chipping materials, the template enables the programming of the puncture in individual feed sequences. The working and withdrawal feed and the dwell time at the end of a feed can be freely defined by the user. The template can be applied to radial outer and inner punctures.

FIG. 11 illustrates an operation template for measuring an outer diameter. The operation template contains a complete measurement strategy for outer diameters including the possibility of correcting a tool with the measured values. The measurement is carried out via a differential measurement in the negative and positive direction of the Y axis. The cycle used for this is filled with content via the parameters from the input mask of the operation template. In addition, the template includes the production of a measurement log as a file on the controller.

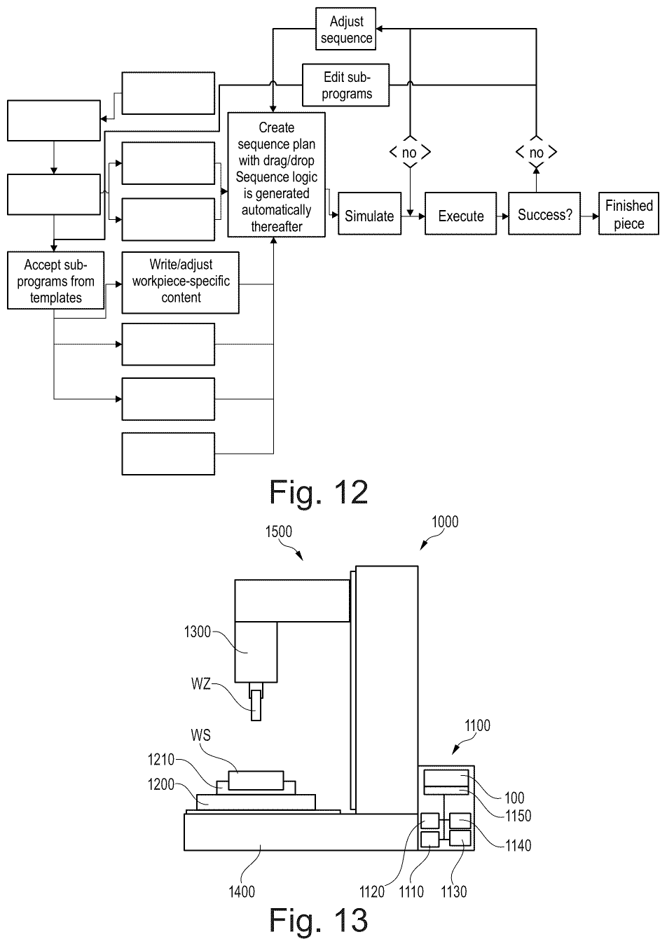

FIG. 12 shows a flowchart illustrating an exemplary embodiment of a method according to the invention for producing a structured NC program (sequence program). Steps that are no longer required compared to a conventional method are shown in dashed lines. The method according to the invention for producing a sequence program eliminates many steps that were previously necessary, so that the present method is significantly simpler and saves time.

According to the invention, the sequence program is automatically generated with its sequence logic on the basis of a schedule that the user can prepare on a graphical user interface by simple gesture control. The stored templates for, for example, component handling or automation are prepared parametrically, so that the user can only take over them and easily adjust them if necessary. The generation of the sequence program can thus be significantly simplified, as a result of which a great deal of time can be saved and potential errors can be avoided.

FIG. 13 shows schematically an exemplary embodiment of a machine tool 1000 with corresponding NC controller 1100. The NC controller 1100 (also referred to as control apparatus) has a storage device 1130 which is configured to provide control data on the NC controller 1100 of the machine tool 1000. The control data can have been transmitted to the storage device 1130, for example, from an external computer or via a network (for example having a plurality of connected computers) to which the NC controller 1100 is connected (not shown here). However, this is intended to be merely exemplary. A flowchart generated according to the method according to the invention comprises control data for controlling the machine tool 1000.

There are of course also further possibilities for transmitting the control data to the storage device 1130, for example by a transportable data memory having been connected to the storage device 1130 (or generally to the NC controller 1100) and thus the data having been transmitted to the storage device 1130.

The NC controller 1100 has a data processing device 1140 which can be configured to analyze the control data on the NC controller 1100 for identifying a subdivision of the NC program 200 into a plurality of program sections 210 indicated in the control data. The NC program 200 can be subdivided by the data processing device 1140, for example according to operations located therein which the machine tool 1000 would perform on the component/workpiece WS to be produced. For this purpose, for example, corresponding commands can be identified as an indicator of a new operation and the subdivision of the NC program 200 can thus be carried out correspondingly.

Moreover, the NC controller 1100 has a human-machine interface 1150 which is configured to generate and/or provide a graphical user interface 100 which can be operated by the operator of the machine tool 1000 on the NC controller 1100 on the basis of the plurality of program sections 210 according to the identification of the subdivision of the NC program 200 indicated in the control data.

In this case, the human-machine interface 1150 can be designed such that an image/information reproduction (for example by a screen) of the graphical user interface 100 is carried out separately from the control/command input (for example by a keyboard with a mouse or the like) on the NC controller 1100, or else the control/command input is carried out integrated in the image/information reproduction of the graphical user interface 100 (for example as a virtual mouse and mouse which are/is designed to be controllably generated in the graphical user interface 100 by touching by the operator).

In particular, the graphical user interface 100 can comprise a plurality of control elements 110, wherein each control element 110 is associated with one of the program sections 210 of the NC program 200. The control elements 110 can be displayed both solely on the image/information reproduction of the graphical user interface 100, or else be controllably integrated in the graphical user interface 100 by touching by the operator. In particular, the graphical user interface 100 can represent a schedule described above.

As a result, the operator can adjust the NC program 200, for example by at least one of the control elements 110 of the graphical user interface 100 being configured such that the corresponding associated program section 210 can be activated or deactivated by the operator, for example by individual operations being added, shifted or removed in the schedule.

In addition to the NC controller 1100, the machine tool 1000, which is illustrated here by way of example in FIG. 13 in a stand design, has a machine bed 1400, a machine table 1200 with workpiece chuck 1210 for chucking the workpiece WS, a work spindle 1300 for driving the tool WZ for machining the workpiece WS, and a stand structure 1500.

In addition, the machine tool 1000 can have a tool changer and/or a workpiece changer and correspondingly a tool magazine and/or workpiece magazine (not shown in FIG. 13 in each case), with the result that corresponding commands and/or parameters can be provided for the machining in the NC program 200 for the control of these additional apparatuses in order, for example, to allow the machining to be carried out in an automated manner. Each of these elements can have a dedicated channel or a column in the schedule.

This can further have the result that the corresponding associated program section 210 can only be activated by the operator if it is established that a tool WZ required for a machining operation corresponding to the program section 210 is provided in the tool magazine of the machine tool 1000. If this is not the case (if the tool WZ is not provided), the NC controller 1100 will deactivate the corresponding program section 210 in the graphical user interface 100. In other words, the schedule will not have a corresponding column, or the cells of the table of the schedule can be activated or deactivated correspondingly.

As already mentioned, the method according to the invention and the control apparatus according to the invention (NC controller 200) are also suitable for other machine types (gantry machines, multi-axis milling centers, etc.) and/or machine types (for example lathes, multi-spindle lathes, eroding machines, laser deposition welding machines, etc.). The list of the examples mentioned is not to be understood as exhaustive, but rather can be extended, for example, by various combinations of machine types/machine models and should also comprise additional machine types/machine models of machine tools.

1. A method for operating a numerically controlled machine tool to design, create, modify and/or execute a sequence program for machining a workpiece, the method comprising the steps of:
providing a graphical user interface as a human-machine interface for inputting input information by a user and outputting output information to the user;
displaying, on the user interface, a project library with a plurality of project templates, each project template comprising a preconfigured sequence of operations for machining the workpiece according to the sequence program;
selecting a project template by a user;
displaying, on the user interface, a parameter display for setting a plurality of process parameters for the sequence program;
setting the plurality of process parameters by the user and storing the process parameters;
displaying, on the user interface, a schedule with a plurality of operations and an order of the plurality of operations;
displaying, on the user interface, an operation library with a plurality of operation templates;
selecting an operation template by the user and placing the operation template at a desired position of an operation in the schedule; and/or relocating an operation template in the schedule;
repeating the selecting and placing and/or relocating of operation templates until the schedule is completed; and
generating a sequence program with corresponding machine and/or control functions according to the schedule and the process parameters and outputting the sequence program to a controller of the machine tool via a control interface.

2. The method according to claim 1, wherein:
the project templates are adopted in a parameterized manner, and/or
each operation template is a sub-program comprising preconfigured machining templates.

3. The method according to claim 1, wherein:
the selecting and placing or relocating of the operation templates and operations are performed by gesture control.

4. The method according to claim 3, wherein the gesture control comprises dragging and dropping.

5. The method according to claim 1, wherein the operation templates and operations are each dynamically adjusted to the desired position in the schedule during the selecting and placing and/or relocating.

6. The method according to claim 1, wherein available positions in the schedule are dynamically adjusted during the selecting and placing and/or relocating of operation templates or operations.

7. The method according to claim 1, wherein the sequence program is automatically generated according to the schedule.

8. The method according to claim 1, wherein control structures are dynamically generated and/or adjusted during the selecting and placing of operation templates in the schedule.

9. The method according to claim 1, wherein:
the settable process parameters are dependent on the machine tool; and/or
the settable process parameters are displayed graphically.

10. The method according to claim 1, wherein the process parameters comprise at least one of the following:
chucking means dimensions of a work spindle;
a clamping force of the work spindle;
workpiece zero points; or
workpiece dimensions.

11. The method according to claim 1, wherein the schedule is a graphical and interactive representation having a row for each operation and a column for each tool carrier and each workpiece carrier.

12. The method according to claim 1, wherein the schedule has a column for each tool carrier and for each workpiece carrier.

13. The method according to claim 1, wherein the method is performed by:
an application on a control device of the machine tool, the control device having an input medium for inputting input information by a user; or
an application on a computer; or
an application in a cloud or on a geographically remote server.

14. The method according to claim 1, wherein the plurality of operations comprise at least one of the following:
accepting a sequence program associated with the schedule;
equipping or preparing one or more chucking means required for the sequence program on the machine tool;
setting up one or more tools required for the sequence program on the machine tool;
loading and/or preparing one or more tools required for the sequence program on the machine tool;
loading and/or programming one or more numerical control (NC) codes, NC programs and/or NC program portions required for the sequence program;
executing one or more NC codes, NC programs and/or NC program portions required for the sequence program;
executing a process monitoring application;
documenting one or more machining processes associated with the sequence program;
performing an automated quality check of one or more machined workpieces; and/or
outputting the sequence program.

15. The method according to claim 14, wherein the plurality of operations comprise at least one of the following:
automatically assembling workpiece pallets;
automatically loading workpiece pallets;
automatically resorting workpieces to workpiece pallets;
setting a clamping position of a workpiece;
changing from one clamping position to another clamping position;
automatically measuring workpieces;
automatically loading a tool magazine of the machine tool;
automatically setting up tools on the machine tool;
automatically resorting tools on the tool magazine; and/or
performing one or more cleaning, maintenance, servicing and/or service applications on the machine tool.

16. The method according to claim 1, wherein the input information comprises one or more of:
model data indicating a computer-aided design (CAD) model of one or more workpieces, one or more workpiece parts and/or one or more tools;
numerical control (NC) data indicating one or more NC codes, one or more NC programs and/or one or more NC program portions;
job data indicating job data associated with workpiece processing;
tool data indicating information about one or more associated tools;
tool list data indicating a list of a sequence program or tools associated with workpiece processing, respectively;
chucking means data indicating information about one or more associated chucking means; and/or
chucking means list data indicating a list of a sequence program or chucking means associated with workpiece processing, respectively.

17. The method according to claim 1, wherein each project template comprises an animation and/or an explanation and/or a graphical illustration of a sequence included in the project template.

18. An operating device for a numerically controlled machine tool, comprising:
a processing device for executing control and operating applications;
a control interface for connecting the processing device to a control device of the machine tool; and
a user interface for displaying a graphical user interface as a human-machine interface for inputting input information by a user and outputting output information to the user, wherein
the processing device is configured to perform a method for operating the numerically controlled machine tool to design, create, modify and/or execute a sequence program for machining a workpiece, the method including the steps of:
displaying, on the user interface, a project library with a plurality of project templates, each project template comprising a preconfigured sequence of operations for machining the workpiece according to the sequence program;
selecting a project template by a user;
displaying, on the user interface, a parameter display for setting a plurality of process parameters for the sequence program;
setting the plurality of process parameters by the user and storing the process parameters;
displaying, on the user interface, a schedule with a plurality of operations and an order of the plurality of operations;
displaying, on the user interface, an operation library with a plurality of operation templates;
selecting an operation template by the user and placing the operation template at a desired position of an operation in the schedule; and/or relocating an operation template in the schedule;
repeating the selecting and placing and/or relocating of operation templates until the schedule is completed; and
generating a sequence program with corresponding machine and/or control functions according to the schedule and the process parameters and outputting the sequence program to a controller of the machine tool via the control interface.

19. The operating device according to claim 18, further comprising a network interface for connecting the processing device to a server.

20. A control apparatus for a numerically controlled machine tool having a control device for controlling machine functions of the machine tool and an operating device connected or connectable to the control device, wherein the operating device comprises:
a processing device for executing control and operating applications;
a control interface for connecting the processing device to a control device of the machine tool; and
a user interface for displaying a graphical user interface as a human-machine interface for inputting input information by a user and outputting output information to the user, wherein
the processing device is configured to perform a method for operating the numerically controlled machine tool to design, create, modify and/or execute a sequence program for machining a workpiece, the method including the steps of:
displaying, on the user interface, a project library with a plurality of project templates, each project template comprising a preconfigured sequence of operations for machining the workpiece according to the sequence program;
selecting a project template by a user;
displaying, on the user interface, a parameter display for setting a plurality of process parameters for the sequence program;
setting the plurality of process parameters by the user and storing the process parameters;
displaying, on the user interface, a schedule with a plurality of operations and an order of the plurality of operations;
displaying, on the user interface, an operation library with a plurality of operation templates;
selecting an operation template by the user and placing the operation template at a desired position of an operation in the schedule; and/or relocating an operation template in the schedule;
repeating the selecting and placing and/or relocating of operation templates until the schedule is completed; and
generating a sequence program with corresponding machine and/or control functions according to the schedule and the process parameters and outputting the sequence program to a controller of the machine tool via the control interface.

21. (canceled)
